(19) United States
(12) Patent Application Publication
(10) Pub. No.: US 2012/0151374 A1
(43) Pub. Date: Jun. 14, 2012

(54) PORTABLE ELECTRONIC APPARATUS AND CONTROL METHOD THEREOF

(75) Inventor: Yung-Hsin LIU, Taipei County (TW)

(73) Assignee: Quanta Computer Inc., Tao Yuan Shien (TW)

(21) Appl. No.: 13/035,263

(22) Filed: Feb. 25, 2011

(30) Foreign Application Priority Data
Dec. 8, 2010 (TW) 99142896

(51) Int. Cl. G06F 3/048

(52) U.S. Cl. 715/740

(57) ABSTRACT

A portable electronic apparatus and a control method thereof are provided. The portable electronic apparatus comprises a display, a first system and a second system. The first system and the second system comprise a first processor and a second processor, respectively. The first processor executes a first operating system to generate a first operating system image, while the second processor executes a second operating system to display a second operating system image on the display. The first processor and the second processor respectively execute a first remote desktop program and a second remote desktop program to set up network communication protocol. When the display wants to display the first operating system image, the first operating system image is displayed on the display via the network communication protocol.

This application claims the benefit of Taiwan application Serial No. 99142896, filed Dec. 8, 2010, the subject matter of which is incorporated herein by reference.

### BACKGROUND OF THE INVENTION

1. Field of the Invention

The invention relates in general to an electronic apparatus, and more particularly to a portable electronic apparatus and a control method thereof.

2. Description of the Related Art

Referring to both FIG. 1 and FIG. 2. FIG. 1 shows a first conventional computer architecture. FIG. 2 shows a second conventional computer architecture. The conventional computer 1 comprises a processor 11, an operating system 12 and a display 13. The processor 11 executes an operating system 12 to display an operating system image on the display 13. The conventional computer 2 comprises systems 20a and 20b. The system 20a comprises a processor 21a, an operating system 22a, a display 23a and an application program 24a. The system 20b comprises a processor 21b, an operating system 22b, a display 23b and an application program 24b. The processor 21a executes an operating system 22a, and executes the application program 24a under the operating system 22a. The display frame of application programs 24a is displayed on the display 23a. Likewise, the processor 21b executes an operating system 22b, and executes the application programs 24b under the operating system 22b. The display frame of application programs 24b is displayed on the display 23b. Some special circuits 25, such as general purpose I/O (GPIO) interface, need to be disposed between the processor 21 a and the processor 21b.

### SUMMARY OF THE INVENTION

The invention is directed to a portable electronic apparatus and a control method thereof.

According to a first aspect of the present invention, a portable electronic apparatus is provided. The portable electronic apparatus comprises a display, a first system and a second system. The first system and the second system comprise a first processor and a second processor, respectively. The first processor executes a first operating system to generate a first operating system image, and the second processor executes a second operating system to display a second operating system image on the display. The first processor and the second processor respectively execute a first remote desktop program and a second remote desktop program to set up network communication protocol. When the display wants to display the first operating system image, the first operating system image is displayed on the display via the network communication protocol.

According to a second aspect of the present invention, a control method of portable electronic apparatus is provided. The portable electronic apparatus comprises a display, a first system and a second system. Te first system comprises a first storage unit and a first processor. The second system comprises a second storage unit and a second processor. The first storage unit stores a first operating system and a first remote desktop program. The second storage unit stores a second operating system and a second remote desktop program. The control method comprises the following steps. A first operating system is executed by a first processor to generate the first operating system image, and a second operating system is executed by the second processor to display the second operating system image. A first remote desktop program and a second remote desktop program are respectively executed by the first processor and the second processor to set up a network communication protocol. When display wants to display the first operating system image, the first operating system image is displayed on the display via the network communication protocol.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a first conventional computer architecture;

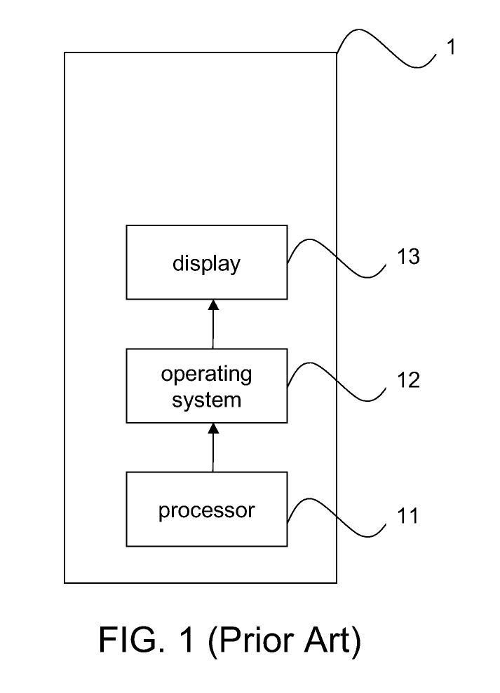

FIG. 2 shows a second conventional computer architecture;

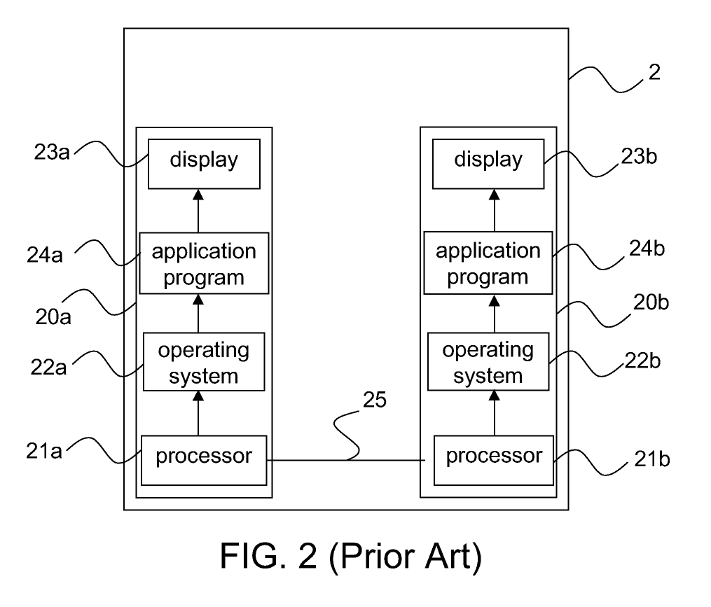

FIG. 3 shows a portable electronic apparatus according to an embodiment of the invention;

FIG. 4 shows a flowchart of a control method of a portable electronic apparatus according to an embodiment of the invention;

FIG. 5 shows a first operating system image; and

FIG. 6 shows a second operating system image.

### DETAILED DESCRIPTION OF THE INVENTION

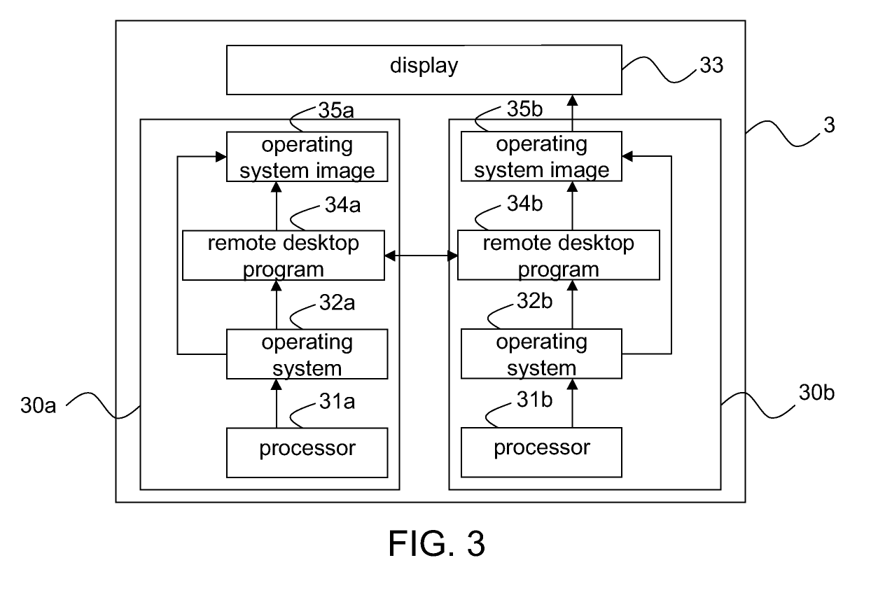

A portable electronic apparatus and a control method thereof are disclosed in a number of embodiments below. Referring to FIG. 3, a portable electronic apparatus according to an embodiment of the invention is shown. The portable electronic apparatus 3, realized by such as a mobile phone, notebook computer, flat computer or AV player, comprises systems 30a and 30b. The system 30a comprises a processor 31a and a storage unit (not illustrated) used for storing an operating system 32a and a remote desktop program 34a. The system 30b comprises a processor 31b and a storage unit (not illustrated) used for storing operating system 32b and a remote desktop program 34b. The processor 31a is used for executing an operating system 32a and the remote desktop program 34a, and the processor 31b is used for executing an operating system 32a and the remote desktop program 34b. The processor 31a executes an operating system 32a to generate an operating system image 35a, and the processor 31b executes an operating system 32b to generate an operating system image 35b. The processor 31a and processor 31b respectively execute the remote desktop program 34a and the remote desktop program 34b to set up a network communication protocol, so that the operating system image 35a can be displayed on the display 35 via the network communication protocol.

The processors 31a and 31b are both formed by an advanced RISC machine (ARM) architecture. When the processors 31a and 31b are both formed by an advanced RISC machine architecture, power consumption can be further saved, and is applicable to the portable electronic apparatus. The operating systems 32a and 32b are respectively realized by WEC 7 and Android. In addition, the processors 31a and 31b can be formed by different architectures. For example, the processor 31a is realized by Intel architecture, and the processor 31b is realized by ARM architecture. The network communication protocol is such as a remote desktop protocol (RDP) or a remote frame buffer (RFB) protocol.

When the network protocol is a remote desktop protocol, the remote desktop programs 34a and 34b are respectively a remote desktop protocol server program and a remote desktop protocol connection program. When the network protocol is a remote frame buffer protocol, the remote desktop programs 34a and 34b are respectively a virtual network computing (VNC) server program and a virtual network computing user program.

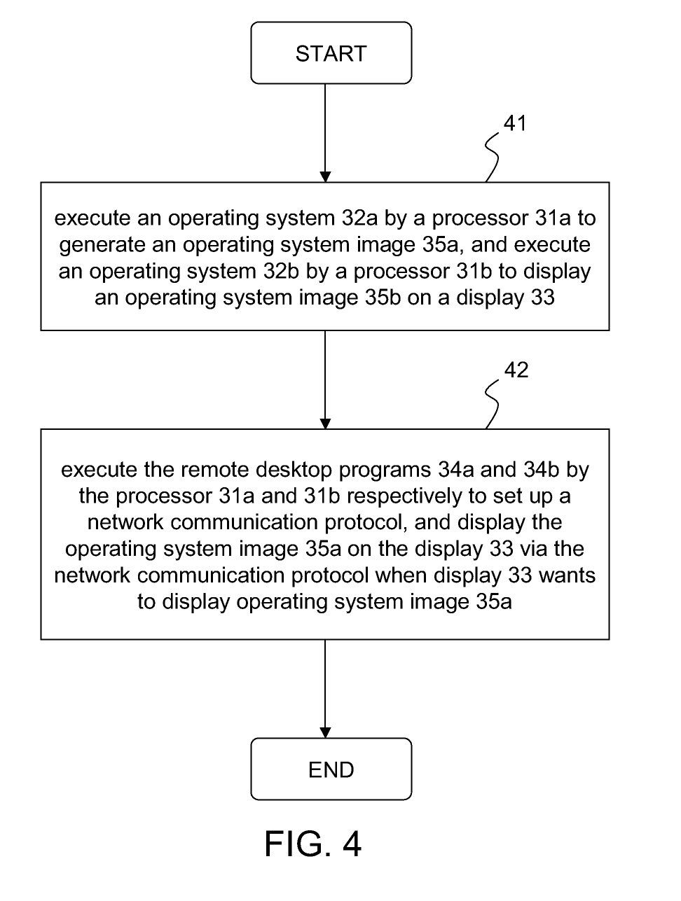

Referring to both FIG. 3 and FIG. 4. FIG. 4 shows a flowchart of a control method of a portable electronic apparatus according to an embodiment of the invention. The control method can be used in the portable electronic apparatus 3. Firstly, the method begins at step 41, an operating system 32a is executed by a processor 31a to generate an operating system image 35a, and an operating system 32b is executed by a processor 31b to display an operating system image 35b on a display 33. The operating system image 35a is such as WEC 7 system desktop, and the operating system image 35b is such as a browser chrome frame. Next, the method proceed step 42, the remote desktop programs 34a and 34b are respectively executed by the processor 31a and 31b to set up a network communication protocol, and when display 33 wants to display operating system image 35a, the operating system image 35a is displayed on the display 33 via the network communication protocol.

Since the portable electronic apparatus 3 only use one display 33, power consumption as well as the volume of the portable electronic apparatus 3 can be greatly reduced. In addition, the portable electronic apparatus 3 only uses one display 33, so the cost is reduced and market competiveness is increased.

When the operating system image 35a is displayed on the display 33, this implies that the user is using the system 30a. Meanwhile, the system 30b further enters power saving mode to greatly reduce power consumption. To the contrary, when the display 33 displays the operating system image 35b, this implies that the user is using the system 30b. Meanwhile, the system 30a further enters a power saving mode to greatly reduce power consumption.

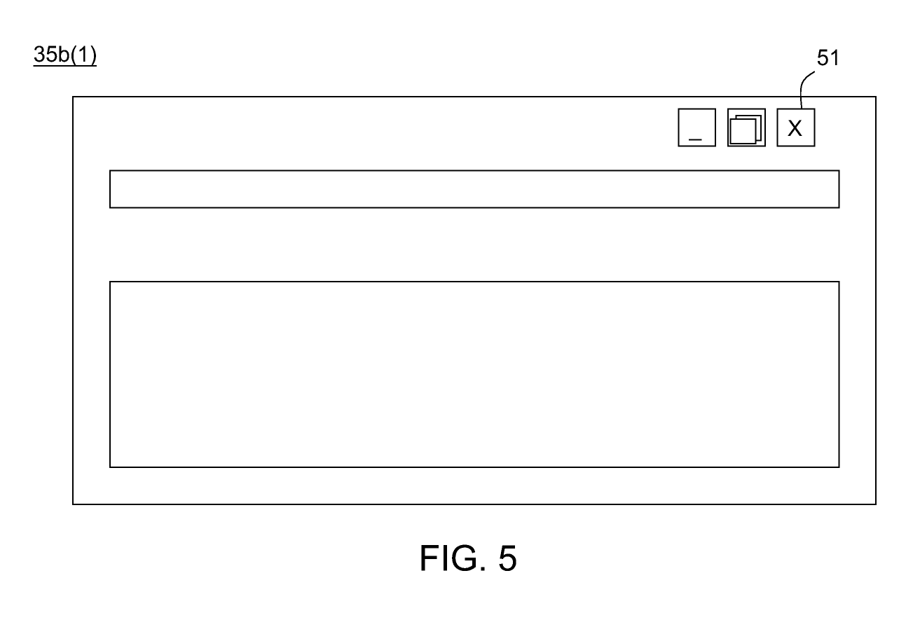

Referring to both FIG. 3 and FIG. 5. FIG. 5 shows a first operating system image. The operating system image 35b of FIG. 3 is such as the operating system image 35b (1) of FIG. 5. The operating system image 35b (1) comprises a shut down icon 51. When the shut down icon 51 is activated, this implies that the user wants to use the system 30a, the operating system image 35a is displayed on the display 33 via the network communication protocol. The system 30b can enter the power saving mode to reduce unnecessary power consumption.

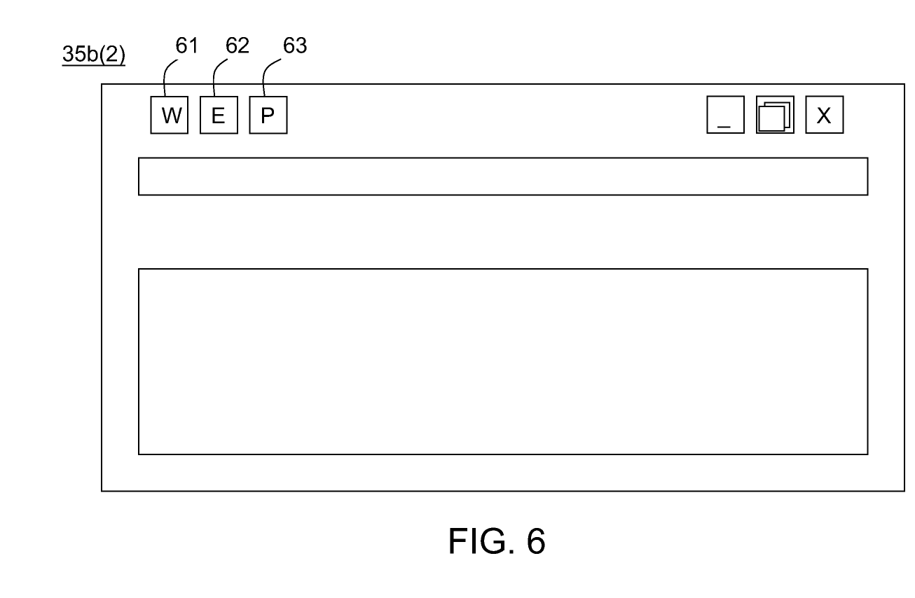

Referring to both FIG. 3 and FIG. 6. FIG. 6 shows a second operating system image. The operating system image 35b of FIG. 3 is such as the operating system image 35b (2) of FIG. 6. The operating system image 35b (1) comprises application program icons 61, 62 and 63. The application program icons 62 and 63 respectively correspond to a number of application programs of the operating system 32a. When one of the application program icons 61, 62 and 63 is activated, this implies that the user wants to use the system 30a, and the operating system image 35a is displayed on the display 33 via the network communication protocol. The system 30b can enter the power saving mode to reduce unnecessary power consumption.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A portable electronic apparatus, comprising:
a display;
a first system, comprising:
a first storage unit used for storing a first operating system and a first remote desktop program;
a first processor used for executing the first operating system to generate a first operating system image;
a second system, comprising:
a second storage unit used for storing a second operating system and a second remote desktop program;
a second processor used for executing the second operating system to display a second operating system image on the display, the first processor and the second processor respectively execute a first remote desktop program and the second remote desktop program to set up a network communication protocol, and when the display wants to display the first operating system image, the first operating system image is displayed on the display via the network communication protocol.

2. The portable electronic apparatus according to claim 1, wherein the network communication protocol is a remote desktop protocol (RDP).

3. The portable electronic apparatus according to claim 1, wherein the network communication protocol is a remote frame buffer (RFB) protocol.

4. The portable electronic apparatus according to claim 1, wherein when the second operating system image is displayed on the display, the first system enters a power saving mode.

5. The portable electronic apparatus according to claim 1, wherein when the first operating system image is displayed on the display, the second system enters a power saving mode.

6. The portable electronic apparatus according to claim 1, wherein the second operating system image comprises a shut down icon, and when the shut down icon is activated, the first operating system image is displayed on the display via the network communication protocol.

7. The portable electronic apparatus according to claim 1, wherein the second operating system image comprises a plurality of application program icons, the application programs respectively correspond to a plurality of application programs of the first operating system, and when one of the application program icons is activated, the first operating system image is displayed on the display via the network communication protocol.

8. The portable electronic apparatus according to claim 1, wherein the first operating system image is a system desktop, and the second operating system image is a browser frame.

9. The portable electronic apparatus according to claim 1, wherein of the first processor and the second processor are both formed by an advanced RISC machine (ARM) architecture.

10. A control method of portable electronic apparatus, wherein the portable electronic apparatus comprises a display, a first system and a second system, the first system comprises a first storage unit and a first processor, the second system comprises a second storage unit and a second processor, the first storage unit stores a first operating system and a first remote desktop program, the second storage unit stores a second operating system and a second remote desktop program, and the control method comprising:
executing a first operating system by the first processor to generate a first operating system image and executing a second operating system by the second processor to display a second operating system image on the display; and
executing a first remote desktop program and the second remote desktop program by the first processor and the second processor respectively to set up a network communication protocol, wherein when the display wants to display the first operating system image, the first operating system image is displayed on the display via the network communication protocol.

11. The control method according to claim 10, wherein the network communication protocol is a remote desktop protocol (RDP).

12. The control method according to claim 10, wherein the network communication protocol is a virtual network computing (VNC) protocol.

13. The control method according to claim 10, wherein when the second operating system image is displayed on the display, the first system enters a power saving mode.

14. The control method according to claim 10, wherein when the first operating system image is displayed on the display, the second system enters a power saving mode.

15. The control method according to claim 10, wherein the second operating system image comprises a shut down icon, and when the shut down icon is activated, the first operating system image is displayed on the display via the network communication protocol.

16. The control method according to claim 10, wherein the second operating system image comprises a plurality of application program icons, the application programs respectively correspond to a plurality of application programs of the first operating system, and when one of the application program icon is activated, the first operating system image is displayed on the display via the network communication protocol.

17. The control method according to claim 10, wherein the first operating system image is a system desktop, and the second operating system image is a browser frame.

18. The control method according to claim 10, wherein the first processor and the second processor are both formed by an advanced RISC machine (ARM) architecture.
